(19) United States
(12) Patent Application Publication
(10) Pub. No.: US 2004/0240954 A1
(43) Pub. Date: Dec. 2, 2004

(54) Ice auger adapter bit for cordless drills

(76) Inventor: Rodney A. Chilcott, Harborcreek, PA (US)

Correspondence Address: Donald W. Meeker, Patent Agent, 924 East Ocean Front #E, Newport Beach, CA, 92661, US

(21) Appl. No.: 10/446,431

(22) Filed: May 28, 2003

(51) Int. Cl. B23B 31/02

(52) U.S. Cl. 408/239 A

(57) ABSTRACT

An adapter device holds a conventional ice auger and mounts the auger on a conventional cordless drill. A rigid elongated shaft has a first end adapted for retaining and operating an auger bit held thereon. A second end mounts on a cordless drill, which is a standard shape of a drill-attaching end of a bit for a cordless drill. A midsection between the two ends has a shield mounted thereon. The shield is larger than the auger and prevents the adapter device from falling through a hole made by the auger bit. The shield comprises an element, such as a rigid disc or rod, rotatably mounted on the elongated shaft so the shield will not spin when the elongated shaft and auger bit are rotating.

### BACKGROUND OF THE INVENTION

1. Field of the Invention

The present invention relates to the field of ice augers and particularly to an adapter to be used between any ice auger and any cordless drill, the adapter having a safety shield to prevent it from falling through a hole in the ice.

2. Description of the Prior Art

In the wintertime in cold climates, ice fishing is popular as a sport as well as a means of obtaining food. Preparatory to ice fishing, the ice fisherman must make a hole in the ice to gain access to the underlying water. The fisherman typically uses an ice auger or drill to accomplish this task. Often a number of holes are drilled. Hand turned augers require much time and energy to operate. Furthermore with most augers, there is a danger of the auger separating from the drill and falling through the hole in the ice into the water below. Large or custom drilling machines are often expensive and can be cumbersome and heavy to transport out onto the ice. The locations of the ice fishing are too distant from sources of electricity to run conventional power cords out onto the ice.

Prior art U.S. Pat. No. 5,915,485, issued Jun. 29, 1999 to McAtavey, provides an auger bit for boring ski post-holes having an elongated shank with a drill head fixed at a first end of the shank. The preferred drill head has diametrically opposed first and second open chip mouths, each defined by an advancing face and a trailing face of the drill head. The advancing face of the drill head may be oriented at a vertical rake angle and at a radial advance angle for propelling debris proximally from the drill head into and through the first and second chip mouths into first and second chip throats. The bit may include first and second excavating helices wound around the shank for a given number of rotations each at a given helix angle whereby first and second chip throats are formed. The second excavating helix may wind around the shank for a lesser number of rotations than does the first whereby a unitary chip throat succeeds the first and second chip throats. Preferably, the bit has an overall length greater than about fifteen inches and a shank that is hollow. The shank and helices may be made from titanium, and a cutting tip of the drill head may be made from tungsten carbide. The bit may be coated with Teflon.

Prior art U.S. Pat. No. 5,330,014, issued Jul. 19, 1994 to Wagner, shows an ice auger conversion apparatus that has an ice auger support and steering mounting member and a winch connected to the ice auger support and steering mounting member. The ring conversion member detachably connects to the winch. A winch drive motor connects to a driven end of the winch. A winch drive socket conversion member connects to a driving end of the winch. One end of a drive conversion adapter member removingly connects to the winch drive socket and another end of the drive conversion adapter member removingly connects to an ice auger shaft member. An ice auger removably connects to the ice auger shaft member. The ice auger support and steering member also has a mounting plate attached to the winch and a steering handle member attached to the mounting plate. A power circuit attaches to the steering handle member to provide power to the winch drive motor. The power circuit has a power circuit actuation switch and a power source. The ice auger has a replaceable blade insert that detachably connects to a distal end of the ice auger shaft member.

Prior art U.S. Pat. No. 4,057,114 issued Nov. 8, 1977 to Anderson, claims a hand-held ice auger. A flexible shaft is connected directly to the crankshaft of a snowmobile engine by a coupler. The flexible shaft drives a reduction gear that is enclosed in a hand-held housing. The reduction gear rotates a drive shaft at a substantially reduced speed and the drive shaft connects to the ice auger bit through a coupler which allows disengagement of the bit when no downward pressure is applied to the housing.

Prior art U.S. Pat. No. 4,971,161, issued Nov. 20, 1990 to Godell, describes an ice auger conversion kit. The ice auger conversion kit is mounted to a conventional grass-trimming apparatus that includes an engine mounted rearwardly of a drive shaft housing with a drive shaft mounted therethrough. The forward end of the drive shaft is of a square drive configuration and is received within a square bore of a rotatable boss coaxially mounted through an adapter head, wherein a forwardmost end of the adapter head includes an axially extending threaded second boss for mounting the ice auger cutting head. The adapter head includes a series of gears to effect a gear reduction therethrough to enhance torque and effect appropriate speed of the ice auger head in use.

Prior art U.S. Pat. No. 4,872,518, issued Oct. 10, 1989 to Crippin, discloses a power chain saw-ice auger conversion apparatus. The conversion apparatus is for use in combination with a chain saw. The apparatus has a housing that includes a rotatable shaft for attachment of a left-hand helical flight ice auger wherein the shaft includes a plurality of bearings secured within either side of the housing with the shaft extending through the housing and formed with a sprocket housing for mating engagement with the chain saw sprocket. A depending extension of the housing includes a plurality of through extending apertures for accepting a plurality of spaced threaded connectors associated with a chain saw.

Prior art U.S. Pat. No. 5,323,674, issued Jun. 28, 1994 to Fidkowski, indicates a cordless drive power driven accessory clamp for rotating the adjustable mechanism of a hand tool to open and close it. The clamp includes spring-biased arms forcing upper jaws toward each other to engage the hand tool and a lower shaft engageable with a drive socket of a power tool. The clamp comprises two clamp arms that are spring biased to force the jaws toward each other for gripping the adjustable mechanism of a hand tool. The clamp is capable of rotating the hand tool to tighten or loosen it depending upon the rotation of the drive socket.

Prior art U.S. Pat. No. 5,865,499, issued Feb. 2, 1999 to Keyser, puts forth a camper crank drive mechanism provides for the powered operation of the top erecting and retracting mechanism of a camper vehicle having a folding top. The present mechanism secures to the camper structure, and has an output shaft that engages the conventional crank input of the camper vehicle. The crank drive mechanism comprises a gear speed reduction unit, which reduces the input speed and multiplies the input torque considerably, in order to allow a relatively small and lightweight battery operated power tool (cordless electric drill, power screwdriver, etc.) to be used to operate the reduction mechanism. The mechanical advantage provided by the mechanism allows it to serve as a mechanical lock of the top erection and retraction mechanism, precluding inadvertent collapse of the top during the intermediate phase of the erection or retraction operation. The power tool used to operate the gear mechanism may be powered by its own internal battery, or may alternatively be powered by a larger external battery, if desired, which external battery may be recharged from the towing vehicle charging system.

Prior art U.S. Pat. No. 6,119,787, issued Sep. 19, 2000 to Garcia, concerns an auger planting tool for boring holes in yards and the like, wherein plants and the like may be conveniently implanted into the soil. The device is attached to a rotating drive device such as a drill or a Weed-Eater type cutting and drill. By triggering the rotating drive device, the auger tool is driven to the intended depth beneath the soil. A detent ring controls the penetration of the auger tool into the soil. An auger spiral flange simultaneously provides a cutting and screwing action attributable to the spiral configuration thereof. The auger spiral flange is fixedly attached to a shaft, and includes plurality of cutting blades and a plurality of contiguous spiral surfaces. These cutting blades forcibly dig into and through the soil bed. An alignment and guide member promotes keeping this downward driving action in a substantially vertical orientation. A churning action caused by the rotating spiral configuration agitates the soil that has been separated from the ground and enables the spiral surface to communicate the loosened soil toward the surface by emulating an upwardly conveying action.

Prior art U.S. Pat. No. 4,807,710, issued Feb. 28, 1989 to Greeley, illustrates an earth auger with a clearing blade near the top of the flight for clearing loose soil from about the mouth of the drilled hole. A second blade is provided at the distal end of the auger within the contour of the flight for cutting of fibrous roots and to loosen the soil to encourage plant root growth.

Prior art U.S. Pat. No. 4,101,238, issued Jul. 18, 1978 to Reibetanz, is for a hole saw for use in a hand drill has a cup centered on a rotation axis and having a rim centered on this axis and provided with a plurality of teeth. This cup has a shaft extending backwardly along the axis and adapted to be received in a drill chuck so that when the shaft and cup are rotated about the axis the teeth can sink into a workpiece and cut a large-diameter hole therein. The cup is formed at its base with a bore lying on the axis and opening into the cup and with a passage extending non-axially from the bore to the outer surface of the shaft. A pilot bit has a shank non-rotatably received in this bore and a tip extending axially beyond the rim of the cup so that this pilot bit serves to center the drill accessory during the start of a hole-making operation. A collar is fitted to the outside of the drill shank over the passage and is connected to aspirating means so as to aspirate particles from inside the cup. Such aspiration can be aided after the start of a drilling operation by removing the drill shank from the bore, or by forming grooves in the shank or the bore for conduction of particles backwardly to the passage.

Prior art U.S. Pat. No. 4,474,513, issued Oct. 2, 1984 to Salyers, provides a portable hand-held device for electricians, plumbers and builders. The device may be used to form in one operation perfectly aligned, craftsman-like holes through a soffit and a roof above, or through a ceiling and a roof above, through which aligned holes an electrical conduit, soil stack or vent pipe, chimney pipe, or the like, may be installed.

Prior art U.S. Pat. No. 6,511,266, issued Jan. 28, 2003 to Groot, shows a wall fishing method and apparatus. Holes can be cut squarely through obstructions hidden within a hollow wall by an apparatus that may include a flexible guide tube that has a work-engaging head at one end; a collared lead screw or other arrangement for bringing the work-engaging head into perpendicular engagement with an obstruction; and a cutting tool for cutting the hole. In a some versions of the invention, two work engaging heads are coaxially attached to the end of the guide tube, inserted into the wall through an access hole, and used to sequentially cut holes through two obstructions. An advantage of this arrangement is that the second, smaller, hole has a large enough diameter to be used for feeding most sorts of flexible lines through the wall. In addition, a panel protecting apparatus is provided so that extensive work can be done within the wall without damaging the margins of the access hole.

Prior art U.S. Pat. No. 2,846,192, issued Aug. 5, 1958 to Ostling, indicates a portable auger device for forming holes in ice. The invention provides an auger type bit that enables a person to precisely drill a hole in the surface of a sheet of ice. The auger device is supplied with a gasoline engine that allows the hole to be drilled with ease and speed.

Prior art U.S. Pat. No. 3,032,126, issued May 1, 1962 to Rexine, puts forth an ice auger that is capable of functioning from the electric power available in a car motor.

Prior art U.S. Pat. No. 3,198,266 issued Aug. 3, 1965 to Mishler, concerns an ice drill of simple and economical construction. The ice drill may be powered by an ordinary automotive battery source or from a relatively low power source as may be available, and does not require any large power consumption.

There is a need for an inexpensive easy-to-use adapter to operate an ice auger to be used with a conventional cordless drill.

### SUMMARY OF THE INVENTION

An object of the present invention is to provide an adapter to hold an ice auger, which can be mounted, on a conventional cordless drill to provide a convenient lightweight easy-to-use way to drill holes in the ice.

Another object of the present invention is to provide a shield in the form of a large circular plate that has a diameter larger than the ice auger cutting width or an elongated rod or ether element longer than the ice auger cutting width attached to the adapter, which prevents the adapter and auger from falling through the hole in the ice, should they become disengaged from the cordless drill.

A further object of the present invention is to provide a recessed portion on the elongated shaft and a central circular opening of the shield that is slightly larger in diameter than the recessed portion of the elongated shaft, which allows the shield to rotate freely from the shaft.

One more object of the present invention is to provide an adapter that will fit any size auger.

An additional object of the present invention is to provide an adapter for an ice auger that may be used with any conventional cordless drill.

Yet another object of the present invention is to provide an adapter for use between an ice auger and a conventional cordless drill that is easy to manufacture.

In brief, an adapter device designed for holding a conventional ice auger and mounting the auger on a conventional cordless drill. The device comprises a rigid elongated shaft that has a first end adapted for retaining and operating an auger bit held thereon. The first end comprises an end opening shaped to receive an auger bit therein. The first end also includes a bit securing opening from the outside of the elongated shaft in the end opening. A bit securing means fits through the bit-securing opening and into the auger bit, thereby securing the auger bit in the end opening.

The device also comprises a second end for mounting on a cordless drill that is capable of turning the elongated shaft to operate the auger bit. The second end is a standard shape of a drill-attaching end of a bit for a cordless drill.

The device further comprises a midsection between the two ends that has a shield mounted thereon. The shield is larger than the auger and prevents the adapter device from falling through a hole made by the auger bit. The shield comprises a plate rotatably mounted on the elongated shaft so the shield will not spin when the elongated shaft and auger bit are rotating. The midsection of the elongated shaft has a recessed portion, which is circular in cross-section and the plate comprises a circular disc that has a central circular opening slightly larger in diameter than the recessed portion of the elongated shaft, this allows the shield to rotate freely from the shaft. The shield is kept from traveling the length of the elongated shaft by means of an upper and a lower shield stop protrusion.

The adapter device is fabricated from a material that is not susceptible to deterioration from moisture and cold.

An advantage of the present invention is that it is convenient.

Another advantage of the present invention is that it is lightweight.

An additional advantage of the present invention is in being easy to use.

One more advantage of the present invention is that it is inexpensive to manufacture.

A corollary advantage of the present invention is that it is durable.

Another advantage of the present invention is that it is trouble free in operation.

Yet another advantage of the present invention is that it fits any auger.

Still another advantage of the present invention is in fitting any conventional cordless drill.

A contributory advantage of the present invention is that it may be used away from a plug in power source.

A further advantage of the present invention is that it will not fall through the hole drilled by the auger.

A final advantage of the present invention is that the shield does not spin when the elongated shaft and auger bit are rotating.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the ice auger adapter of the present invention aligned for inserting in a cordless drill chuck with the auger bit aligned for insertion in the adapter and showing a circular disc shield;

FIG. 2 is a side elevational view of the ice auger adapter of FIG. 1;

FIG. 3 is a perspective view of the ice auger adapter of FIG. 1 having an alternate shield in the form of an elongated rod rotatably mounted on the ice auger adapter shaft.

### BEST MODE FOR CARRYING OUT THE INVENTION

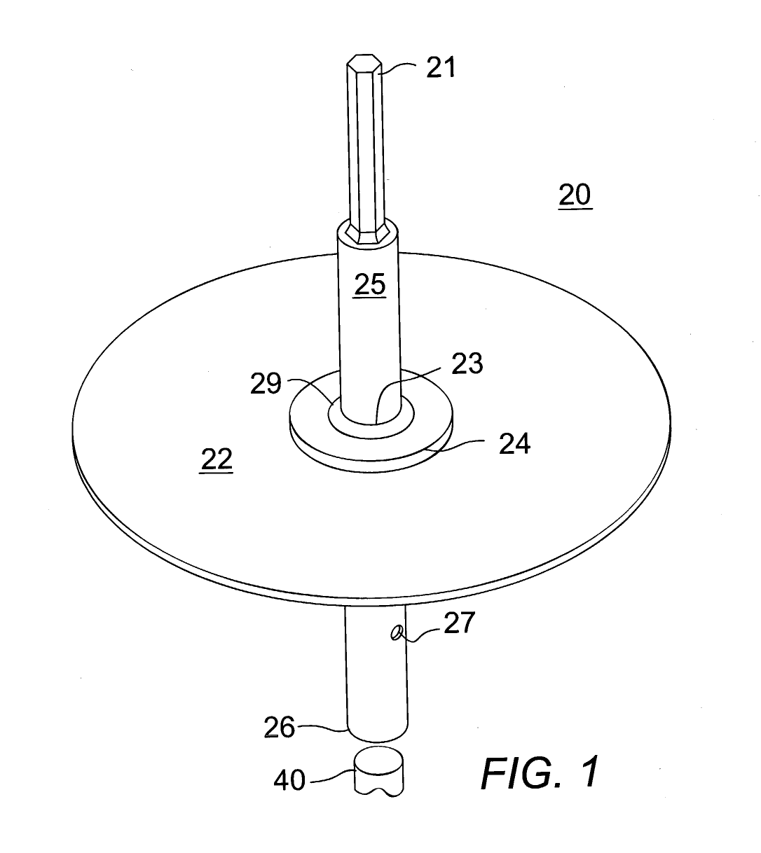

In FIGS. 1-3, an adapter device 20 and 20A holds a conventional ice auger 40 and mounts it on a conventional cordless drill 30. The device 20 and 20A comprises a rigid elongated shaft 25 that has a first end 26 adapted for retaining and operating an auger bit 40 held thereon. The first end 26 comprises an end opening shaped to receive an auger bit 40 therein. The first end 26 further comprises a bit securing opening (not shown) from the outside of the elongated shaft 25 in the end opening. A bit securing means (not shown) fits through the bit-securing opening 27 and into the auger bit 40 to secure the auger bit 40 in the end opening of the first end 26.

The adapter device 20 also comprises a second end 21 adapted for mounting on a cordless drill 30, which is capable of turning the elongated shaft 25 to operate the auger bit 40. The second end 21 comprises a standard shape of a drill-attaching end of a bit for a cordless drill 30, as shown in FIG. 1.

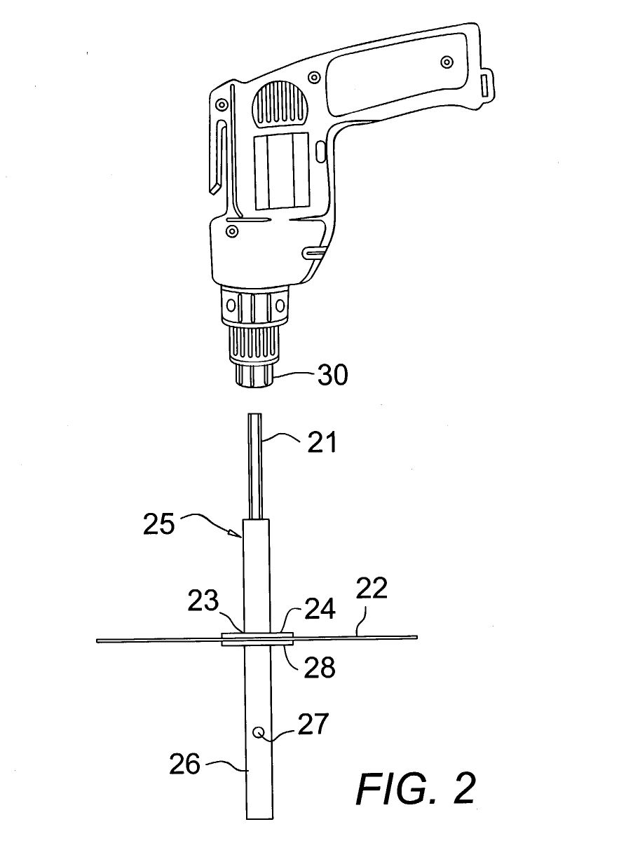

The adapter 20 further comprises a midsection 23 between the two ends 21 and 26 that has a shield 22 and 22A mounted thereon, as shown in FIGS. 1-3. The shield 22 an 22A is larger than the auger 40 drilling width so the shield 22 and 22A is capable of preventing the adapter device 20 from falling through a hole made by the auger bit 40. In FIGS. 1 and 2, the shield 22 comprises a plate 22 rotatably mounted on the elongated shaft 25 so that the shield 22 does not spin when the elongated shaft 25 and auger bit 40 are rotating. The midsection 23 of the elongated shaft 25 comprises a recessed portion, which is circular in cross-section and the plate 22 comprises a circular disc that has a central circular opening slightly larger in diameter than the recessed portion of the elongated shaft 25, thereby allowing the circular disc 22 to freely to rotate on the recessed portion of the elongated shaft 25, so turning the elongated shaft 25 does not turn the circular disc 22. The midsection 23 of the elongated shaft 25 further comprises an upper shield stop protrusion 24 and a lower shield stop protrusion 27 spaced apart in the midsection 23. The circular disc 22 is free to rotate on the midsection 23 of the elongated shaft 25 between the upper shield stop protrusion 24 and the lower shield stop protrusion 28, so the turning the elongated shaft 25 does not turn the circular disc 22.

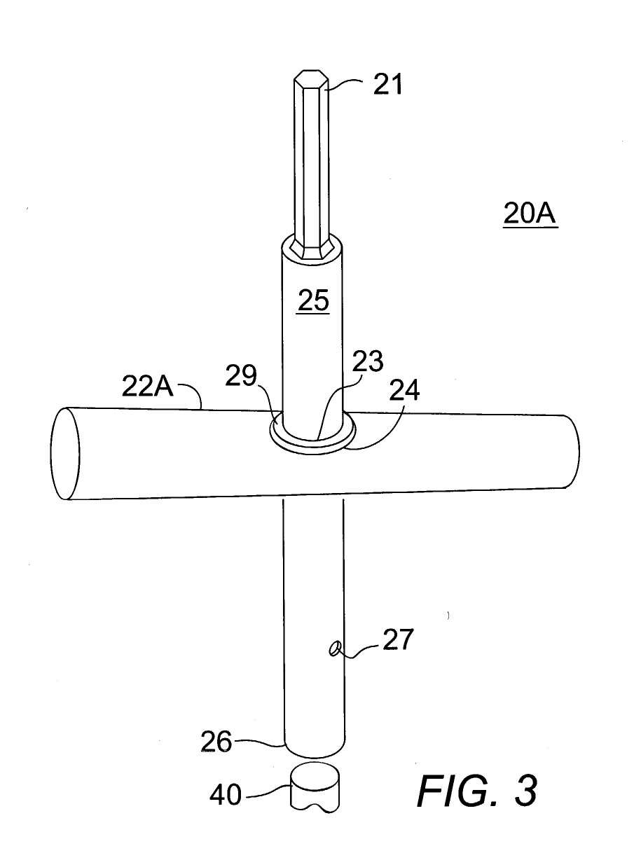

In FIG. 3, an alternate shield comprises an elongated rod 22A longer than the drilling width of the auger 40 mounted on the shaft 25 in a similar fashion to the disc 22.

A bearing 29 may be mounted between the shield 22 and 22A and the shaft 25 to reduce the friction between the shield and the shaft further.

The adapter device 20 is fabricated of a material not susceptible to deterioration from moisture and cold, preferably machined and welded steel.

In practice, a user would insert the bit end 40 of the ice auger into an end opening of the first end 26 of the adapter 20, which is shaped to receive an auger bit 40 therein. The user would then insert a bit securing means through the bit-securing opening (not shown) and tighten the bit securing means into the auger bit 40, thereby securing the auger bit 40 in the end opening of the first end 26. The user would then insert the second end 21 of the adapter 20 into the chuck 30 of any conventional cordless drill, and adjust the chuck 30 to hold the adapter 20 firmly. In use the disc 22 or rod 22A spins freely in between the upper disc stop protrusion 24 and lower disc stop protrusion 28 and around the midsection 23 of the elongated shaft 25, thereby keeping the disc 22 or rod 22A from spinning as the shaft 25 and auger bit 40 rotate. The disc 22 is larger in diameter and the rod 22A longer than the hole created by the auger bit 40, thereby preventing the adapter 20 from falling into the drilled hole.

It is understood that the preceding description is given merely by way of illustration and not in limitation of the invention and that various modifications may be made thereto without departing from the spirit of the invention as claimed.

What is claimed is:

1. An adapter device for holding conventional ice augers for mounting on a conventional cordless drill, the device comprising:
a rigid elongated shaft having a first end adapted for retaining and operating an auger bit held thereon, a second end adapted for mounting on a cordless drill capable of turning the elongated shaft to operate the auger bit, and a midsection between the two ends having a shield mounted thereon, the shield being larger than the auger so that the shield is capable of preventing the adapter device from falling through a hole made by the auger bit.

2. The adapter device of claim 1 wherein the shield comprises a rigid element rotatably mounted on the elongated shaft so that the shield does not spin when the elongated shaft and auger bit are rotating.

3. The adapter device of claim 2 wherein the midsection of the elongated shaft comprises a recessed portion of the elongated shaft which recessed portion is circular in cross-section and the rigid element is provided with a central circular opening slightly larger in diameter than the recessed portion of the elongated shaft, the rigid element being free to rotate on the recessed portion of the elongated shaft so that turning the elongated shaft does not turn the rigid element.

4. The adapter device of claim 2 wherein the midsection of the elongated shaft is circular in cross-section and further comprising an upper shield stop protrusion and a lower shield stop protrusion spaced apart in the midsection and the rigid element is provided with a central circular opening slightly larger in diameter than the midsection of the elongated shaft, the rigid element being free to rotate on the midsection of the elongated shaft between the upper shield stop protrusion and the lower shield stop protrusion, so the turning the elongated shaft does not turn the rigid element.

5. The adapter of claim 2 wherein the rigid element comprises a circular disc larger in diameter than the ice auger drilling width.

6. The adapter of claim 2 wherein the rigid element comprises an elongated rod longer than the ice auger drilling width.

7. The adapter device of claim 1 wherein the second end comprises a standard shape of a drill attaching end of a bit for a cordless drill.

8. The adapter device of claim 1 wherein the first end comprises an end opening shaped to receive an auger bit therein and further comprising a bit securing opening from an outside of the elongated shaft in the end opening and a bit securing means to fit through the bit securing opening and into the auger bit to secure the auger bit in the end opening.

9. The adapter device of claim 1 wherein the adapter device is fabricated of a material not susceptible to deterioration from moisture and cold.

10. The adapter device of claim 9 wherein the elongated shaft is fabricated of steel.
